(19) United States
(12) Patent Application Publication
(10) Pub. No.: US 2022/0388592 A1
(43) Pub. Date: Dec. 8, 2022

(54) Boaz Bikes Model 3 Vehicle

(71) Applicant: Emil I Nnani, Corsicana, TX (US)

(72) Inventor: Emil I Nnani, Corsicana, TX (US)

(21) Appl. No.: 17/340,097

(22) Filed: Jun. 7, 2021

(51) Int. Cl. B62K 3/12; B62M 6/85; B62K 5/027; B62K 3/00; B62J 17/08; B62J 43/10; B62J 6/20; B62J 11/00; B62J 45/40; B62J 1/08; A42B 3/30

(52) U.S. Cl. CPC B62K 3/12; B62M 6/85; B62K 5/027; B62K 3/002; B62J 17/08; B62J 43/10; B62J 6/20; B62J 11/00; B62J 45/40; B62J 1/08; A42B 3/30; B62K 2202/00; B62K 2204/00

(57) ABSTRACT

Systems and methods are disclosed herein for an interchangeable electric scooter with seating option for 2 passengers is proposed. The assembly provides various advancements including but not limited to a glossy finish, a rectangular front frame member, an aerodynamic manual brake fin, a communication device support member, floor and front panels having multiple colors and designs, On/Off digital locking system, front and back cameras, solar panel, retractable umbrella, cell phone charging spot and holder, Bluetooth connectivity, GPS enabled, smart helmet, an integrated router forming a Wi-Fi hotspot, a daytime running lamp and back lit lights, number plate, a help switch, a sound system, a camera for livestream and social media synchronization, a communication device charger, an integral GPS.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

Embodiments relate to a scooter device, and more particularly relates to a rechargeable battery and solar powered vehicle that provides multiple enhanced options to the user.

### Description of the Related Art

Riding for fun and exercise is very popular among individuals of all ages and disabilities. To make the riding easy, safe, and more enjoyable among kids, adults, and physically challenged people, a wide variety of fuel-less riding systems, such as, scooters, bicycles, are suggested in the prior art. In recent years, scooter riding is one of the biggest fads among riding enthusiasts. Scooters appeal to both adults and children for their fun use and ability to be used as legitimate transport. However, one of the problems associated with one type of scooters is that the user must stand at all times and propel the unit with a foot. This can be tiring for the ride and can also cause user to become off-balance while riding. Typically, scooters are ridden by a single person at a time and cannot be used by two persons at once. Further, with the rise in consumer affluence, consumers are willing to pay a little more for the convenience, appearance, and dependability. But, the conventional riding systems neither appeal nor are convenient for portability and packaging purposes. Furthermore, the conventional riding systems are heavy, complex in use, and non-durable for years of effective use.

U.S. Pat. No. 4,852,898 teaches improvement in a pedal-operated polycycle including a hydraulic cylinder in fluid; pressure integral communication with piston means depending from such pedals; a hydraulic line in substantial co-alignment with the mainframe of the polycycle; an input of the hydraulic line being in communication with the hydraulic cylinder; and a rear wheel drive secured in rotational relationship with both an output of the hydraulic line and a tangent surface of the rear wheel of the polycycle. Riding is can be tiring for the ride and can also cause user to become off-balance while riding. The typical scooters are ride by a single person at a time and can not be used by two persons at once. This system is heavy, non-portable, and complex. It can not be used by two persons at once. Further it does not enable the user to ride in a standard manner and then switch to a seated riding style when desired.

U.S. Pat. No. 6,375,208 provides a combined skateboard scooter comprising a handlebar, a front body, a transmission device, a wheel device, and a board. A rear end of the front body is pivoted to the board and includes a slot through which a steering rod extends. The steering rod is attached to the handlebar to move therewith and movable along the slot. The transmission device is engaged with the steering rod and the wheel device such that back and forth movement of the steering rod urges the wheel device to move forward via transmission by the transmission device. The wheel device includes wheels attached to front and rear ends of the board. The user may stand on the board and operate the handlebar and the steering rod to move back and forth to thereby move the combined skateboard scooter forward. This system is heavy, not portable, and complex. It can not be used by two persons at once. Additionally, this can be tiring for the ride and can also cause the rider to become off-balance while riding.

U.S. Pat. No. 6,769,706 teaches a scooter having a steerable front wheel assembly, a rear wheel assembly and a frame linking the front and rear wheel assemblies. The scooter has a drive mechanism comprising front and back crankshafts rotatably attached to the frame and attached to left and right pedals. The front crankshaft transmits power to the rear wheel by means of a front sprocket gear, a continuous chain and a rear sprocket gear. This system is also complex. It cannot be used by two persons at once. This can be tiring for the ride and can also cause rider to become off-balance while riding.

There are multiple inventions that have been proposed in prior art regarding scooters. However, their utility hasn't been observed to be utilized to maximum limit because of multiple technical design issues including but not limited to be not used by two persons at the same time, while making the riding ideal among individuals of all ages and disabilities. The conventional riding systems neither appeal nor are portable. Furthermore, conventional riding systems are heavy, complex in use, non-durable for years of effective use; limited in steering capabilities causing difficult for some users; lack of smoothness of running at the time of operation; storage areas, added batteries, navigation and tracking systems; inefficient use and spread of energy and multiple other sorts of technical failures.

The current invention proposes an enhanced design of a lightweight, simple in use and durable riding system that can be used by two persons at the same time, while also providing easy, safe, and more enjoyable riding to kids, adults, and physically challenged people. The present invention provides multiple types of advancements which haven't been observed in prior art and will be discussed in later part of patent.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of two individuals using the scooter at same time.

It is also the objective of the invention to provide a device consisting of solar panel on top of the basket to help recharge the batteries. There are dual batteries in the rear of the vehicle, where when one is depleted the second battery automatically start providing energy to the device.

It is moreover the objective of the invention to provide a system where alternator in rear of the trunk recharges the battery when depleted.

It is also the objective of the invention to provide a system which has provision of retractable umbrella/owning covering which can be utilized by an auto click on the hinges so they snap in place when extended or let down.

It is moreover the objective of the invention to provide a safety reflector on the rear of the umbrella to help with being seen at night.

It is also the objective of invention to provide a Cell phone holder with charging port available.

It is also the objective of invention to provide Bluetooth in anterior portion of the scooter that automatically connects to any phone that's inserted into the cell phone holder.

It is further the objective of invention to provide front and rear motion detecting cameras that saves the footage to the cloud by using the cell service that is coming from the IOT device to track and control the scooter.

It is further the objective of the invention to provide a dual and reliable system where the features remain operational and intact even after long time usage.

It is moreover the objective of the invention to provide a system which is made of high-quality plastic and steel to provide not only luxury look and feel, but very sturdy construction to last.

It is also the objective of the invention to provide a front and rear turn signals that's controlled by a lever instead of buttons to control a turn signal.

It is moreover the objective of the invention to provide a scooter device which is of a durable and reliable construction.

It is also the objective of invention to provide noise detection that detects gunshots, car accidents and more and notifies the proper authorities.

It is further the objective of the invention to provide a security tag which is easy to use, inexpensive and is easy to carry thus is highly portable and provides an advance methodology in similar domain.

It is also the objective of the invention to provide the feature of the scooter to be a stand-up scooter or a sit-down scooter. If user wants to stand up, they are able to raise the neck to the handlebars to the proper heigh with a self-locking mechanism and they are able to fold the seat completely down to give them more foot space like a stand-up scooter. Once required to be lowered the user can just raise seat and lower handlebars to ride again.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an exemplary full view of the invention.

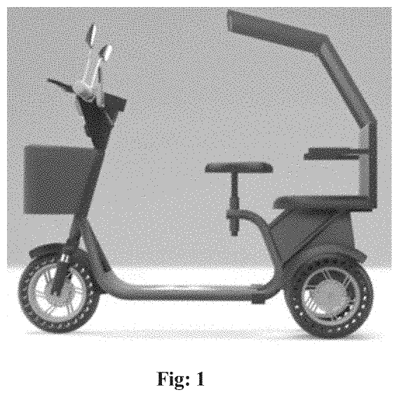

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

For convenience of a short-distance travel, an electric scooter may be set as a shared electric scooter to be leased by a user, which requires to put multiple electric scooters in public places. However, the existing electric scooter has the defects that the scooter is easily damaged and lost, is not safely charged and occupies a large space. Furthermore, the electric scooters are powered by storage batteries, such as lead-acid battery. The development of such conventional electricity storage has continued for more than ten years, yet the performance of the conventional storage battery as a power source for electric scooter is not satisfactory to the general consumers.

Furthermore, vehicles have a sound system and a security system. The sound system usually consists of an AM/FM radio, a cassette or CD (compact disk) player, an equalizer/amplifier, and speakers. The radio and player are arranged in a metal casing or housing that is mounted in a dashboard of the vehicle. Further, vehicles are being equipped with a navigation system that incorporates a global positioning system (GPS) receiver. The GPS receiver has an antenna to receive signals from a satellite network. The vehicle navigation system uses the satellite positioning signals to compute coordinates that locate the vehicle over the surface of the earth with regard to longitude, latitude, and altitude. Also, with the appropriate map software, the vehicle's location can then be shown on a map.

In many instances, cellular communications systems have been added to vehicles. These communications systems enable the vehicle driver or occupant to transact telephone calls from their vehicle. Some systems are voice controlled which permit the driver to initiate or receive calls while traveling without removing a hand from the driving wheel, or diverting the eyes from the operation of the vehicle.

Other proposals have involved Internet connectivity vehicles. The problem with these vehicles is that they do not provide electrical energy simultaneously with connectivity to a personal communication device. Also, they do not provide aesthetic design features. Even though the above cited Internet connectivity vehicles meet some of the needs of the market, a mobile connectivity and self-generating illumination electric scooter that provides both transportation and communication mean simultaneously.

The current invention as per its preferred embodiments provides a system which provides a high-end electric and solar powered scooter with enhanced functionalities.

The system as per its preferred embodiments provides an electric scooter comprising a scooter frame having a rear cover inside which a fuel cell stack is mounted in an inclined manner and a center cover connected to the rear cover by a footstep section. A blower is arranged inside the footstep section for causing an air flow through the fuel cell stack. A humidifier is also arranged inside the footstep section for maintaining a proper humidity level for the fuel cell stack. A front cover is mounted to a front side of the scooter frame and forms an interior space with the center cover. A heat dissipation system comprising a coolant container containing a coolant and a heat exchanger through which the coolant flows is arranged inside the front cover. A pump drives the coolant through the fuel cell stack for cooling purposes. The coolant that is heated by the fuel cell stack is driven through the hydrogen canister holder to maintain the hydrogen storage canisters at a proper operation temperature.

As further described in this document, the present invention provides varies assemblies and locations of the battery packs in the scooter.

In one aspect, the present invention provides an electric scooter comprising: a vertical tube, connected to a handle bar element; a platform configured to support a rider; at least one front wheel and at least one rear wheel; an electric motor configured to provide a mechanical power to at least one of the front and rear wheels; and a battery housing configured to removably receive and hold one or more battery packs, wherein the one or more battery packs are configured to power the electric scooter, and at least one battery pack is capable of being used as a power supply of a separate electric power or gardening tool.

In some embodiments the scooter has dual tires in the rear to help with extra weight and cutdown on the bike tip overs.

In some embodiments the scooter has tubeless tires to cut down the cost of fixing flats.

In some embodiments the scooter has extra seat to allow two users to ride at once. It further has enclosed basket to keep items safe and away from blowing once user is riding.

In some embodiments the scooter has dual swappable batteries to allow longer riding before swapping batteries. Furthermore, the solar panel provides additional support to rechargeable batteries.

In some embodiments the scooter has retractable umbrella for light coverage against harsh weather conditions. The cell phone holder can carry and provide charging spot for smart devices.

In some embodiments the scooter provides full safety reflector on the rear side for safe driving at night. The built in Bluetooth speaker, front and rear motion detecting cameras, navigation and display system, front and rear turn indicators, tracking device and identification plate to help and trach the scoter are also the enhanced functionalities.

In some embodiments the scooter has backup tracking device inside the scoter body to help fight theft.

In some embodiments the scooter has sanitation wipes comer to receive wipes, smart helmet locking and placing system, dual brake handles for safety, adjustable seating option, running lights, high beam light and horn are also present in the proposed assembly.

In some embodiments the scooter has sensor screws that notifies if there is theft attempt on the assembly. The accident alert sensors will notify the impact of vehicle damaged. It also has nose detection sensors to detect gunshots and car accidents.

In some embodiments the scooter can be converted into stand-up scooter or a sit-down scooter. If user wants to stand up, they are able to raise the neck to the handlebars to the proper heigh with a self-locking mechanism and they are able to fold the seat completely down to give them more foot space like a stand-up scooter. To lower it again, user can raise seat and lower handlebars to ride again.

The assembly is preferably made of high-quality plastic and steel which allows complete 360-degree movement of assembly without any feebleness.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

I. A shared scooter assembly providing enhanced features including:
A shared scooter assembly as per claim I, where solar panel on top of the basket to help recharge the batteries;
A shared scooter assembly as per claim I, where dual batteries are present to provide power to vehicle and are backed up by solar panel;
A shared scooter assembly as per claim I, where retractable umbrella can be opened and closed by a single click;
A shared scooter assembly as per claim I, where safety reflectors on the rear of the umbrella help enhanced visibility at night;
A shared scooter assembly as per claim I, where phone holder with charging capabilities is present at anterior portion;
A shared scooter assembly as per claim I, where Bluetooth allows seamless connectivity to smart devices;
A shared scooter assembly as per claim I, where front and rear motion detecting cameras save the footage to the cloud by using the cell service that is coming from the IOT device to track and control the scooter;
A shared scooter assembly as per claim I, where cell phone holder connects to the IOT device via Bluetooth to offer turn by turn GPS on a full LCD screen;
A shared scooter assembly as per claim I, where GPS in the frame of the body that can't be removed without cutting the scooter apart;
A shared scooter assembly as per claim I, where smart helmet connects to the phone in the cell holder that also records and saves the footage to the cloud;
A shared scooter assembly as per claim I, where smart helmet turns signals on the rear of the helmet and a microphone to answer hands free calls;
A shared scooter assembly as per claim I, where sensor screws that send out an audible noise when being loosen along with the GPS location to centralized servers;
A shared scooter assembly as per claim I, where noise detection detects gunshots, car accidents and more and notifies the relevant authorities; and,
A shared scooter assembly as per claim I, where scooter can be interchanged between standing and sitting scooter.
